(19) United States
(12) Patent Application Publication
(10) Pub. No.: US 2018/0148356 A1
(43) Pub. Date: May 31, 2018

(54) SYSTEM FOR THE PRODUCTION OF HYDROGEN FROM SEA WATER

(71) Applicant: BOUND4BLUE, SL, Castelldefels (ES)

(72) Inventors: Jose Miguel Bermudez Miquel, Piera (ES); Cristina Aleixendri Munoz, Piera (ES); Ignacio Bermudez Sanchez, Piera (ES); David Ferrer Desclaux, C/Castillejos, 361 (ES); Francisco Jose Saenz Saenz, Lleida (ES)

(21) Appl. No.: 15/556,311

(22) PCT Filed: Mar. 9, 2016
(86) PCT No.: PCT/ES2016/070150

§ 371 Date: Feb. 6, 2018

(30) Foreign Application Priority Data
Mar. 10, 2015 (ES) P201530306

(51) Int. Cl. C02F 1/461; B63B 35/44; B63H 9/06

(52) U.S. Cl. CPC C02F 1/46104; B63H 9/0614; B63B 35/44

(57) ABSTRACT

The invention relates to a system for the production of hydrogen from sea water. Said system comprises a ship (1) provided with sails (2) for capturing wind in order to move the ship, at least one turbine (3) which is disposed underneath the ship in order to remain submerged in the water and which is made to rotate by the action of the water flowing via same when the ship (1) moves in relation to the water, an electric generator (4) adapted to convert the rotation of the turbines (3) into electrical energy, a system (5) for generating hydrogen from the electrical energy generated, and hydrogen storage means (6). The sails (2) have a profile that can be configured between a folded non-operative position and an unfolded operative position, wherein they determine the profile of the rail and therefore the aerodynamic surface for contacting with the wind.

### TECHNICAL FIELD OF THE INVENTION

This invention relates to an energy conversion system, and more specifically, a system for converting the force of wind from seas and ocean in electric energy and non-fossil fuel, thanks to the electrolysis of sea water H₂ and/or O₂.

Specifically, this invention relates to a system for the production of hydrogen, oxygen, methanol, ethanol, ammonia and/or other chemical species, from sea water, the type that consists of at least one ship fitted with sails for capturing the wind to move the ship; at least one turbine placed under the ship in order to stay submerged in the water and its rotation is caused by water flowing through turbine when the ship moves in the water: a generator adapted to convert the rotation of at least one turbine into electricity; a system for producing hydrogen, oxygen, methanol, ethanol, ammonia and/or other chemical species on the ship, from the electric energy generated by the generator; and storing means for hydrogen, oxygen, methanol, ethanol, ammonia and/or other chemical species.

### BACKGROUND OF THE INVENTION

Different systems for obtaining hydrogen through using different types of energy are known. However, up until now, obtaining hydrogen was not generally very competitive.

Generating electric energy on sailboats through using propellers attached to small generators has been known for some time, for example in documents U.S. Pat. Nos. 3,619,632; 3,895,236; 4,102,291 and 4,335,093. Such devices are typically used to charge the battery and normally create a significant dredge effect on the ship. Generating energy on a larger scale by means of sail propulsion has required maximum generation capability through using a maximum amount of sail.

Making use of this requirement and possibility, currently takes place in a number of systems of hydrogen production by electrolysis using the electricity generated by the generating system based on the turbines on sailboats that have a large sail capacity. For example, in patents AT507229; ES2326710; DE102007057267; U.S. Pat. Nos. 5,027,735; 7,146,918; 8,601,960, among others. In these sailboats, the force of the wind drives the sailboat causing its movement. Such movement causes water to flow through the turbines, causing a rotating movement, thus obtaining the resulting mechanical energy. This is transferred to the generator, turning it into electricity. Subsequently, the electricity is used in the production of hydrogen (H₂) in order to obtain such element. The obtained hydrogen can be pressurized and stored in the storage unit.

However, this profusion of attempts, which has been shown solely in various illustrative examples, up until now hasn't been accomplished in a versatile, economical and easy to operate device.

Specifically, the closest state-of-the-art that attempts to find a solution to the aforementioned need, would be patent U.S. Pat. No. 7,146,918, which describes an electricity and hydrogen (H₂) generation system, from sea water and wind power, in sailboats, according to the preamble in claim 1.

The problem with this generating system of U.S. Pat. No. 7,146,918, is that the sails are difficult to operate, control and regulate, and due to that there is lower performance and predictability in the generation of electricity and H₂. For example, a major problem is that if the wind turns 180° this requires the sails to be rotated, which can be difficult and dangerous. One of the purposes of this invention is to solve this problem and for the operability, efficiency and predictability of the system to increase.

### EXPLANATION OF THE INVENTION

To that end, the object of the invention is a system for the production of hydrogen from sea water, of the type mentioned at the beginning, with a stiff sail like the one shown at the beginning, that has configurable profile, with novel concept and functionality, and that is essentially characterized by the characterizing part of claim 1.

In claims 2 and subsequent, preferred embodiments of the system of the present invention are disclosed.

### BRIEF DESCRIPTION OF THE DRAWINGS

The attached drawings show, in a non-limiting example, a mode of embodiment of the system for the production of hydrogen from sea water. In these drawings:

FIG. 1, is a depiction of a ship showing the system of the invention;

FIG. 2, is a detailed view according to II of FIG. 1, that specifically shows the electric generator, the hydrogen/oxygen production system, and the storage means of hydrogen/oxygen,

FIG. 3, is a plan view of the profile of the sail according to the invention, in its folded position:

FIG. 4, is a similar view of FIG. 3, but with the profile of the sail in an unfolded position, with the inflatable bags inflated;

FIG. 5, is a perspective view of the stiff sail of FIG. 4;

FIG. 6, is a plan view that shows the inflation mode of an example of inflating the bag of the sail of this invention;

FIG. 7, is a perspective view that corresponds to the plan view of FIG. 6; and

FIG. 8, is a plan view and partially cropped one of the ship of FIG. 1, wherein the speeds of the ship (Vb), the true wind (Vr) and the apparent wind (Va) are shown.

### DETAILED DESCRIPTION OF THE DRAWINGS

In the said drawings, it can be seen the constitution and the operating mode of an embodiment of the system for the production of hydrogen from sea water of the invention. In this case, the system is mounted on a ship 1 that carries, in this example of embodiment, five sails according to the invention. Obviously, the concept is extendable to any sail ship carrying a different number of sails 1.

The invention is based on the combination of wind speed with the high density of water, this yields a higher performance than any other system that is based on wind as a primary energy source.

It is mainly a ship 1 specially designed for the production of hydrogen (and/or oxygen), obtained from the electrolysis from sea or lake water.

In the drawings, one can see that the system for the production of hydrogen from sea water, according to this invention, consists of:

a ship 1, designed for and in charge of supporting all the necessary structural loads and holding the storage system inside;

equipped with stiff sails 2, responsible for propelling the vessel so that it attains speed;

submerged turbines 3, that spin due to the relative speed of the ship and water and this generates mechanical energy, while at the same time feeding the electrolysis equipment and auxiliary equipment. The turbines 3 rotate due to the relative speed of the ship 1 and water and this generates mechanical energy, while at the same time feeding the generation systems of H₂ 5 and the auxiliary equipment of the ship 1;

an electric generator 4 adapted to convert the rotation of the turbines 3 into electricity;

a hydrogen generation 5 system on board for producing H₂ and O₂ from the electric energy generated by the generator 4;

storage means 6, based, for example, on ISO high pressure containers for H₂ and O₂ (at 30 bar, 300 bar or higher).

According to this invention, there are different possible variations to the H₂ generation system, including, and without limitation:

by chemical electro-activation (ECAS) of sea water in ECAS cartridges 11 through adding an electrolyte. In this case, it can be fed with an additional electrolyte, or just the salinity of the sea water may be enough; and

a system for water electrolysis through membranes of elements 10 of filtration, microfiltration and/or ultrafiltration.

The process in which the H₂ and O₂ is generated and stored is as follows:

The ship 1 leaves the port with a motor (not shown), whether conventional or with a hydrogen fueled cell battery and the ship goes towards an area with strong winds.

Once there, the ship 1 will shut off the motor and use a sail, using the stiff sails 2 in question, following the direction of the maximum strength of the wind in order to reach high speeds. The higher the speed of the ship 1, the higher the production of hydrogen and oxygen.

In this process, the ship reaches speed relative with the sea, which is used to generate mechanical energy through the submerged turbines 3.

With this mechanical energy, transformed into electricity, the hydrogen 5 generation systems and auxiliary equipment are fed for the electrolysis or chemical electro-activation (ECA) of the previously conditioned water, separating it into hydrogen and oxygen or other chemical species in the case of ECA (e.g. Cl and its compounds).

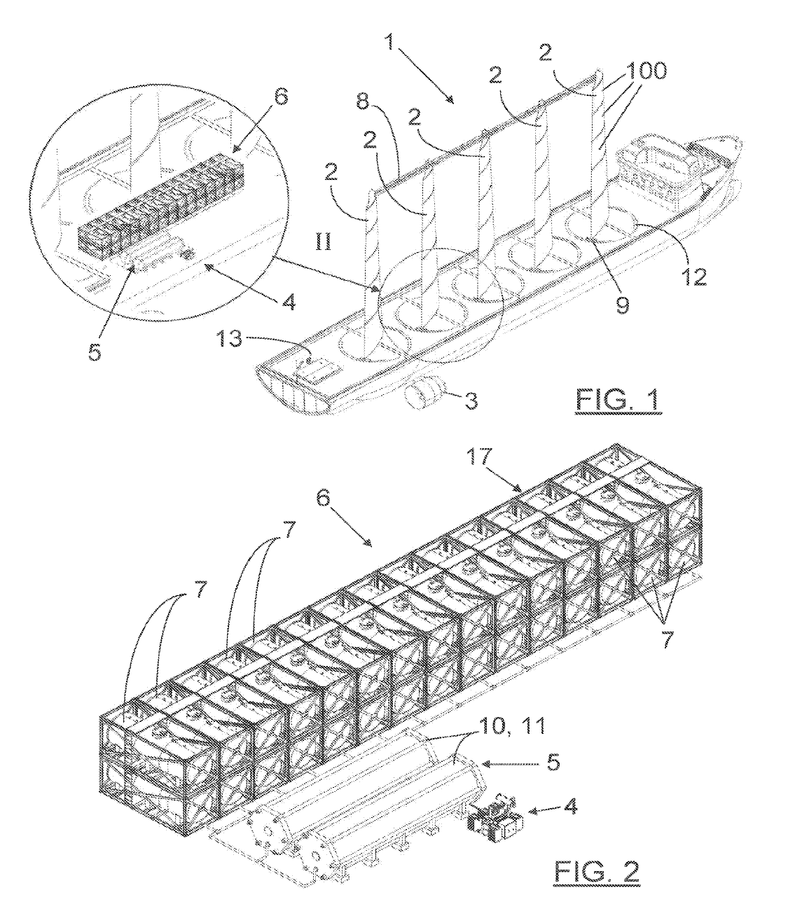

The gases will be stored pressurized on board, in a gaseous state initially or through chemical or cryogenic storage, in gas storage means 6, seen in the illustrated example (FIGS. 1 and 2), in tanks 7 for hydrogen, oxygen, etc.

When the tanks 7 or chemical storage (cells) components are full, the ship 1 returns to port to unload and start the process again.

Ideally, storage should be done with standard pressurized ISO containers, which can then be unloaded in any port without needing special infrastructure, although it is envisaged that other storage means can be used, such as large spherical tanks or chemical elements for storage (cells).

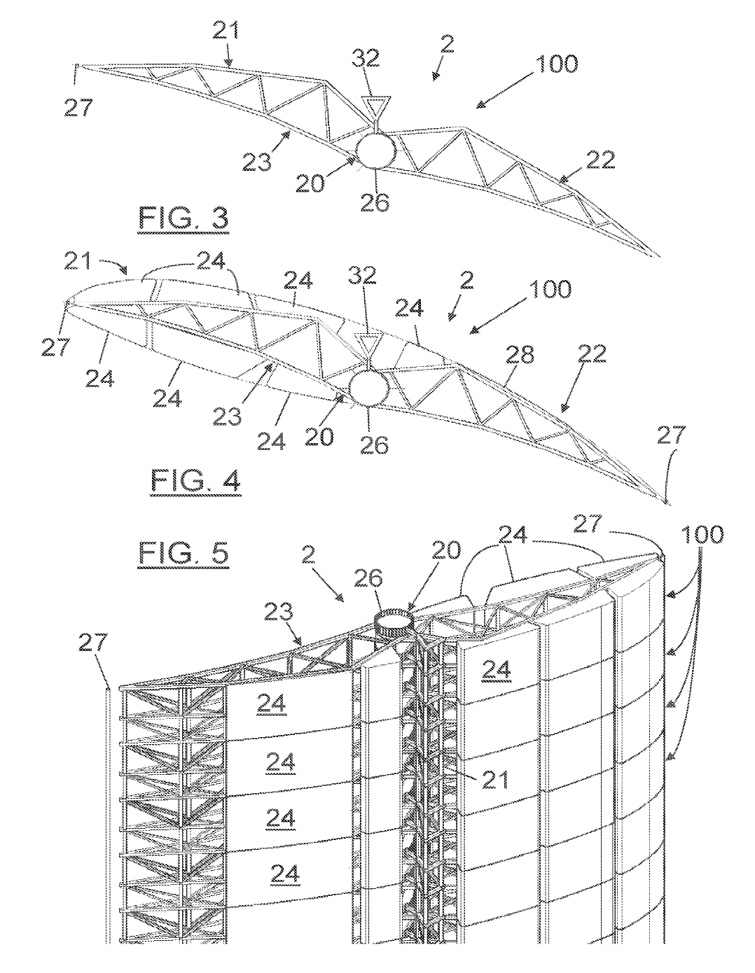

According to the invention, the sails 2 are stiff sails with a configurable profile between a non-operative folded position (FIG. 3), and an unfolded operational position (FIGS. 1, 4 and 5), which determine the profile of the sail 2 and as such the aerodynamic surface that makes contact with the wind. Preferably, the sails (2) in their inflated and stiff form have the profile of the wing of an airplane, which can be symmetric or asymmetric (which is the example that is shown in the drawings).

Each sail 2 is comprised of profile 100 elements (FIGS. 3, 4 and 5), divided in two equal pivoting sections 21, 22 on a joint 26 like a tube, with a shaft 20 on both sides, and they have a support structure 23, like a lattice, where there are a few sail elements 24, consisting of inflatable bags 24, operated individually or jointly, by a few inflating 30 measures, between a deflated position, corresponding to the folded position, and an inflated and stiff position, corresponding to the unfolded position, in which the profile of the sail 2 is determined and as such the aerodynamic surface that makes contact with the wind.

The structure 23 in lattice, in the shape of the trailing edge of the aerodynamic profile, so that when the inflatables have to be setup, it will not be necessary to work with the half profile ones that can be left completely without being inflated.

Once the both sections 21 and 22 of the profile 100 elements have been fixed and anchored, and the profile 100 elements have been set, the sails 2 can rotate around the shaft guided in their lower part by a cart 9 with bearings around circular guides 12 of the covering 13 of the ship 1.

The central shaft 20 distributes the load to the entire ship and receives the mounting bracket of the support structure 23 lattice. All the profile 100 elements are anchored to the central shaft 20.

There are vertical elements 27 on the two borders of the support structure that guide the outer shell 28, that may be folded or placed below the structure, covered, or in the upper part. This outer shell 28 can be a technical fabric that adapts to the shape of the sail 2 profile at all times, and that encloses the set of inflatable bags 24. For greater clarity, FIGS. 1 and 5 show the sails 2 without the outer shell 28.

The shaft 20 as it is shown consists of a triangular reinforcement column 32, which gives more inertia to the support structure 23. FIGS. 2 to 5.

As an additional point, the set of sails 2 can be attached by an above bridge 8 (FIG. 1), that provides the set more inertia.

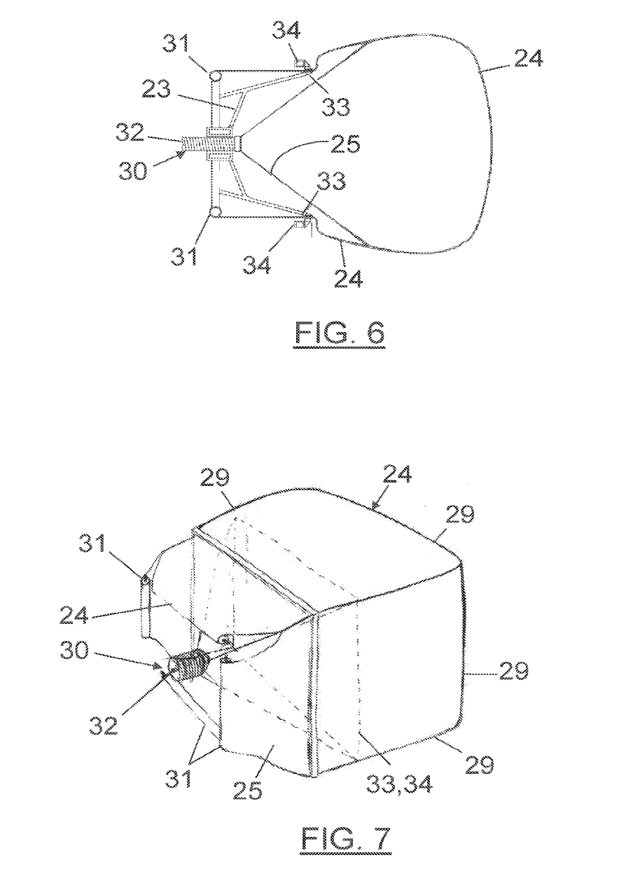

As mentioned, to create the aerodynamic profile, the set has a series of elements of inflatable sails 24 that can inflate at will through some inflating measures 30, through pressurized air using tubes and pressure systems distributed throughout the whole support structure 23 of the sail 2, so that sail 2 can at all times adopt this system in various shapes and configurations. A non-limiting example of the functioning of the inflatable sail elements 24 is described below, with particular reference to FIGS. 6 and 7:

The inflating system 30 for configuring the adaptable profiles consists of inflatable bags 24, preferably of plastic (for example PVC), with an inner shell 25.

This said inflatable bag 24 is tightened by about 31 motorized rollers that collect or release the inflatable bag 24, while the inner shell 25, which is joined by an inflatable bag 24 through a heat-sealed or similar union, it has an air pressurized injection tube 32, this tube will be fixed to a frame on the support structure 23, that will keep it set at one position and additionally creates support for holding the inner frame 33.

This inner frame 33 is prepared inside an inflatable bag 24 but outside the shell 25 and has its analogue in the outer frame 34, which has a guiding purpose, that can tighten and loosen the “cloth” of the inflatable bag 24. The outer frame 34 is fixed to the general structure as well as the inner frame 33. This frame, gives stability, positioning and stiffness to the tangential forces, that the wind could cause.

The sail 2 made from inflatable bags 24 is also rigidizable. For this purpose, the inflatable bag 24 has some stiffening measures, some ways to inflate with preformed stitching 29 (FIG. 7), so that the inflatable bag 24 increases or decreases in volume, but in a stiff way and designed beforehand, in the same way as car “airbags”. In FIGS. 4 and 5 you can clearly see how the inflatable bags 24 have different shapes and maximum volumes, once they have reached an operating unfolded and stiff position.

With the invention, one can create configurable and adaptable volumes, for any system that needs this possibility, as could be the case for sails with a configurable profile, or blades for wind turbines.

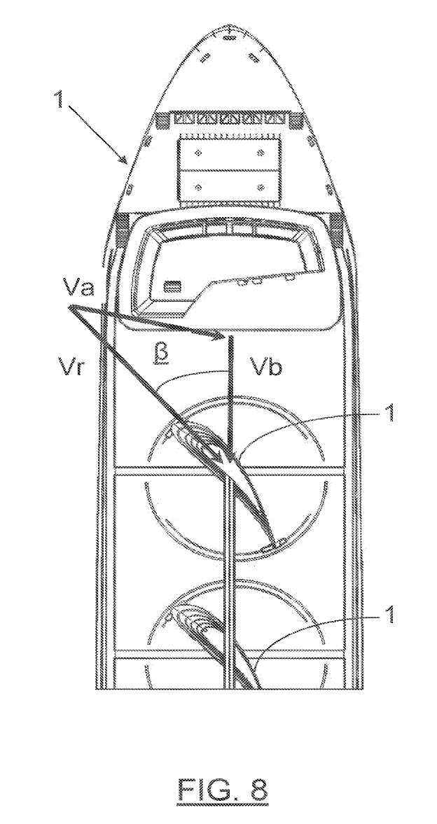

Lastly according to the invention, the apparent wind angle (β) is between 30° and 75°. In seamanship the apparent wind, or the speed of the apparent wind (Va) is defined as the vector sum of the speed of the true wind (Vr) plus the speed of the ship (Vb). And so, the angle (β) of the apparent wind is the angle that forms the apparent speed (Va) and the speed of the ship (Vb). This is shown in FIG. 8.

Those skilled in the art will notice that the sails 2 of the system of the invention have complete symmetric duality, now it's possible to configure the sails 2 from one side to the other, and according to varying volumes, making it unnecessary to rotate 180° in case the wind comes from the opposite side. Also, for certain variations of the direction or speed of the wind, the ship of the system of this invention does not need to modify its direction.

When this invention is sufficiently described, along with the way of putting it in practice, it is noted that when things are not altered, changed or modified from their fundamental principle, it remains subject to detail variations.

In this sense, the stiff and configurable profile sails 2 of the system of hydrogen production of this invention may have other forms of operation, different from what is explained in relation to the preferred operation based on inflatable elements or bags 24. For example, at least of the following variations been considered appropriate for use in the system of this invention:

the sail disclosed in patent U.S. Pat. No. 8,601,966B2, wherein the sail is configured from elements of the sail that are stackable and expandable as bellows; and

the sail disclosed in the patent application EP2202144A1, wherein the sails are determined by lateral expandable and retractable elastic elements.

Similarly, the number of profile 100 elements, as well as the elements of the sail (or inflatable bags) 24, can be any type, including the unit, leaving it within the scope of protection of the claims.

Finally, it's worth noting that whereas this invention has been explained in relation to the production of hydrogen, the principles of the invention may be applied to the production of other chemical species suitable to the storage of energy, such as for example, without limitation, oxygen, ethanol, methanol, ammonia, etc.

What is claimed is:

1. A system for the production of hydrogen from sea water, of the type that comprises a boat fitted with sails for capturing the wind to move the ship; at least one turbine placed under the ship in order to stay submerged in the water and its rotation is caused by water flowing through turbine when the ship moves in the water; an electric generator adapted to convert the rotation of at least one of the turbines into electricity; a system for generating hydrogen H₂ from the electric energy generated; and hydrogen storage means, characterized in that the sails have a configurable profile between a folded non-operative position, and an unfolded operational position, that determines the sail profile and hence the aerodynamic surface that makes contact with the wind.

2. A system for producing hydrogen, according to claim 1, characterized in that the sails are stiff sails, by stiffening means.

3. A system for the production of hydrogen from sea water, according to claim 1, characterized in that the sails consist of at least one inflating sail and stiffening element, operated by inflation and stiffening means, between a folded position, corresponding to the non-operational folded position, and the operational unfolded position, wherein the configurable profile sail is inflated and stiff.

4. A system for the production of hydrogen, according to claim 1, characterized in that the sails have the profile of an airplane wing.

5. A system for the production of hydrogen, according to claim 4, characterized in that the profile of the airplane wing is selected between a profile of a symmetrical airplane wing and a profile of an asymmetrical airplane wing.

6. A system for the production of hydrogen, according to the claim 1, characterized in that the profile of each sail is divided in sections on both sides of a shaft, and comprises a support structure, upon which are mounted the said inflatable elements, which are composed of inflatable bags, operated by the said inflating and stiffening means.

7. A system for the production of hydrogen, according to claim 6, characterized in that the sails can rotate around a shaft guided in their lower part by a cart with bearings around circular guides of the covering of the ship.

8. A system for the production of hydrogen, according to claim 6, characterized in that the shaft comprises a triangular reinforcement column, which gives more inertia to the support structure.

9. A system for the production of hydrogen, according to claim 1, characterized in that the sails (2) are covered on the exterior by a technical fabric that adapts to the shape of the profile of the sail at all times, and that encloses the set of inflatable bags (24).

10. A system for the production of hydrogen, according to claim 1, characterized in that the generation system of H₂(4) is a water electrolysis system.

11. A system for the production of hydrogen, according to claim 1, characterized in that the generation system of H₂ is by chemical electro-activation of sea water in ECAS cartridges (11) through the addition of an electrolyte.

12. A system for the production of hydrogen, according claim 1, characterized in that the apparent wind angle (β) is comprised between 30° and 75°.

13. (canceled)
